(19) United States
(12) Patent Application Publication
(10) Pub. No.: US 2007/0152642 A1
(43) Pub. Date: Jul. 5, 2007

(54) Wireless glass-mounted lighting fixtures

(76) Inventor: Philip George Franklin, Anaheim, CA (US)

Correspondence Address: Philip G. Franklin, 1636 S. Clementine Street, Anaheim, CA, 92802-2901, US

(21) Appl. No.: 11/649,676

(22) Filed: Jan. 3, 2007

Related U.S. Application Data
(60) Provisional application No. 60/755,906, filed on Jan. 3, 2006.

(51) Int. Cl. G05F 1/00

(52) U.S. Cl. 323/201

(57) ABSTRACT

A method of inductively powering light fixtures through glass or other non-ferrous material is disclosed that results in the light fixture itself not needing wires for operation, thereby simplifying and lowering the cost of the installation process, and allowing for the fixture to be completely sealed and protected. Such light fixtures are useful for automotive and household or business decorative or advertising use.

### BACKGROUND-CROSS REFERENCES TO RELATED APPLICATIONS

This patent application is related to Provisional Patent Application No. U.S. 60/755,906 filed on Jan. 03, 2006, by this applicant, Philip George Franklin, Anaheim, Calif., entitled “Wireless Glass-Mounted Lighting Fixtures”, and applicant requests benefits and rights of priority thereof enure to the benefit of this application and applicant.

### BACKGROUND-FIELD OF INVENTION

This invention relates to the transmission of power to operate a lamp or light emitter in a glass-mounted lamp fixture, or to a lamp fixture mounted to other non-ferrous material.

### BACKGROUND-DESCRIPTION OF PRIOR ART

In the past, glass-mounted lighting devices required the lighting device to be directly supplied with power through wires. Some inventions have disclosed the art of using conductive paint applied to a glass surface as a replacement for mechanical wires, wherein traces of conductive paint are applied to glass sheeting and used as part of the pathway to directly supplying power to the light emitting device or lamp.

Some inventions have disclosed and discussed the art of creating holes in glass material to mount the lamp fixture as well as to facilitate a path for wires to travel so the fixture can be supplied with direct power.

In all of these applications and teachings of the art of lighting and lamp fixtures, a conductive pathway—be it by way of wires, conductive paint, or other metallic connection—has always been required. No design or method has been taught whereby a sealed lamp or lighting fixture can be powered without the need of direct connection to power, and therefore enable a light fixture to be mounted to a glass or non-ferrous plane, without the need to use wires. This is especially limiting in the application of adding a lamp or lighting fixture to the outside of a pane of glass wherein the glass is already mounted and fixed, and neither its removal nor its physical modification is judged to be a practical solution.

### OBJECTS AND ADVANTAGES

The invention has practical and direct application in the automotive field in the example of glass-mounted coach lights on a car or limousine, as well as practical application of glass-mounted lights and specialty decorations used, for example, on a building's glass front windows during the Christmas and Halloween seasons, or to light advertising media.

Accordingly, several objects and advantages of my invention are to facilitate adding a functional lighting fixture or lighted device to a flat or curved plane of glass or non-ferrous material:
(a) Wherein the outside light fixture is fully sealed to keep out moisture, without the need to have an opening for the entry of wires;
(b) Without the need to supply wires directly to the fixture;
(c) Without the need to try to hide or disguise wiring;
(d) Without the need to drill holes in the glass;
(e) Without the need to add conductive paint to the glass;
(f) Without the need to dismount or dissemble the glass pane;
(g) Without the need to weakening the intrinsic ability of the glass to resist breakage from accident or mechanical or thermal strain because one or holes were made to the glass;
(h) Without the need to expose the installer of the light fixture to claims for weakening the intrinsic ability of the existing glass assembly to keep out water from the interior of a car or building;
(i) Without the need to drill holes in the body of the car to route the wires to mount the light or light fixture;
(j) Without the need to require the use of complex circuitry to invert lower voltages to higher voltages in the case of using electroluminescent lamps; and
(k) Greatly reducing installation time and costs.

Further objects and advantages of my invention will become apparent from a consideration of the drawings and ensuing description.

### DRAWING FIGURES

FIG. 1 shows an electrical schematic of a basic working circuit of my invention.

FIG. 2 is a side-view diagram of my invention installed showing the exciter on one side of glass, and the receiving light fixture on the other.

FIG. 3 shows a block diagram of the exciter fixture used in a preferred embodiment of my invention.

FIG. 4 shows a block diagram of the receiver fixture used in a preferred embodiment of my invention.

FIG. 5 shows a block diagram of the receiver fixture used in an alternative embodiment of my invention.

FIG. 6 shows a block diagram of the receiver fixture used in an alternative embodiment of my invention.

### REFERENCE NUMERALS IN DRAWINGS

100 Exciter Inductor
110 Tank Capacitor
120 Exciter Transistor
130 Frequency Source
140 Car Battery
150 Receiver Inductor
160 Tank Capacitor
170 Light Emitting Diode
180 Glass Panel
200 Power Cord
210 Exciter (Primary) Fixture
230 Receiver (Secondary) Housing
240 Lamp Lens
300 Car Battery Block
310 Power Input Block
320 Microprocessor Block
330 Power Switching Block
340 Inductive Tank Block
350 Emitted Inductive Energy
400 Received Inductive Energy
410 Inductive Tank Block
420 Power Filter Block
430 Microprocessor Block
440 EL Lamp Element #1
450 EL Lamp Element #2
520 Aux Power Filter Block
530 EL Lamp
540 Audio Amplifier Block
550 Audio Speaker Block
600 Household AC Power
610 AC Power Input Block

### SUMMARY

This invention proposes to conduct power through glass and non-ferrous materials for use for the emission of light from a lighting fixture or lamp through the use of inductive coupling, thereby removing the need for the supply of power to an external lamp or light fixture using wires or other conductive metallic pathway.

Accordingly, the reader shall see that by placing two coils (inductors) on opposite side of a piece of glass or other non-magnetic-blocking material, the invention utilizes the transfer of energy by utilizing the magnetic coupling between two or more inductors to supply energy to a light emitting device. That is, the two coils in effect create a transformer, so that AC power applied to the coil mounted inside glass is coupled to the coil mounted to the outside of the glass, with the transferred power then utilized through appropriate circuitry to energize a lamp or other light emitter.

The art, of course, is more complicated in actual application then just gluing two coils to a piece of glass, as revealed later herein, but the true basis of my invention is the utilization of inductive coupling to power lighting fixtures, especially to power those fixtures mounted to glass.

I hereby present two simplified instances of application to illustrate my invention:

Illustration 1: By simplified example and illustration of the basis of my invention, but not by any way a limitation, in the application of a vehicular coach light that is to be applied for operation to the glass panel on the outside of a limousine, two fixtures are assembled and installed to effect the light.

The first fixture is the power transmitter that is mounted to the inside of the pane of glass of the vehicle. The fixture includes an inductor (coil) device of appropriate size and value mounted inside the fixture and so oriented that when the fixture is properly fixed to the glass, the inductor is positioned appropriately to maximize coupling through the glass (mounted so as to maximize the lines of force transmitted through the glass). The fixture is then glued or otherwise fixed to the inside of the glass. The inductor device is fed power of appropriate voltage and frequency, so that the magnetic (inductive) energy emanating from the inductor is in part available on the other side of the glass. It is helpful in the application of the inductor that it is so manufactured as to focus the magnetic lines of force towards the glass surface. A good method for coupling power to the inductor includes using a capacitor in parallel with the inductor to create a tuned inductor-capacitor tank circuit that maximizes the transfer of energy through the glass at an appropriate frequency. A DC-to-AC inverter circuit is also supplied to facilitate the conversion of direct current to an alternating current of appropriate frequency, amplitude, and inductance, for use with the transmitting inductor.

The second fixture of this illustrative application, is a lamp fixture that contains a light source—an Light Emitting Diode (LED) in this example—that is so constructed as to allow the lamp fixture to be glued to the outside of the glass without the use of mounting holes. Internal to the fixture is an inductor (coil) device of appropriate size and value attached to a light emitting LED device, although it is possible to not use a resonant tank circuit tuned to the same frequency, or an harmonic frequency, of the first fixture that is mounted inside the glass, adding an appropriate capacitor in parallel with the inductor increases the efficiency of the power transfer. The recovered energy is then coupled to the LED at the appropriate voltage and current. The mounting of the lighting fixture is so performed as to align the inductor coil of this second fixture in axial alignment with the coil of the inductor in the first fixture mounted to the inside of the glass. In this way the magnetic lines of force and energy are maximally coupled between the two inductors, and therefore the available energy delivered to the lamp or other light emitting device is sufficient for illumination of same.

Illustration 2: The second illustration is also a wireless lighting art that utilizes inductive coupling between coils, but makes the use of an Electro-Luminescent lamp (EL lamp) instead of an LED. In this example, an EL lamp about the size of a Business Card is used, and can be manufactured using printing in various inks to look like an existing business card—hence giving the ability of persons to mount a glowing business card to any glass surface, whether at home, at work, or on their car. Alternatively in this example, the EL lamp may be in the form and color of a pumpkin or candy cane—the morphology of the emitter is not restricted in this example.

In this illustration, we also have two fixtures. The first is the energy transmitter and is fixed to the inside of the glass; and the second is the energy receiver and lamp fixture which is fixed to the outside of the glass.

In this example, the inductor of the energy transmitting fixture mounted inside the glass is manufactured to be a large-diameter coil that is much thinner so that the transmitter is a relatively large but flatter fixture than the example above, and in fact the coil is manufactured using a simple repeating circular trace on a PCB.

The outside EL lamp fixture may be encased in a sealed assembly that also utilizes a simple repeating circular trace on a PCB, and therefore appears to the casual viewer to be a flat and flexible sheet in the form of a business card that is attached and simply glued to the glass surface. The fixture can include a tuned-tank circuit to couple the recovered energy at a voltage appropriate for operation of the EL lamp. That is, the two coils may in effect form a transformer so that a low voltage coupled to the inside inductor circuit of the pseudo-resonant transformer, may result in a recovered high voltage at the output of the second inductive circuit so that an EL lamp may be directly operated without further conversion. This process involves adjusting the turns ratio of the two inductors, harmonic tuning, a combination of techniques, or by other known techniques of voltage boosting.

In this illustrative application, the EL fixture fixed to the outside of the glass may be easily swapped with other fixtures so as to accommodate changes to a message or the outline of the lamp (that is, as an example, to allow a candy cane-shaped lamp to be substituted for a pumpkin-shaped lamp.

A possible variation of this illustration of the use of my invention could be that instead of glue, magnets or suction cups are used to fix the glowing display or card (both inside and outside pieces have magnets or suction cups installed and appropriately oriented), so the printed message could be easily changed or used to assign identification numbers or other numbers or titles to cars on a temporary basis.

### DESCRIPTION OF INVENTION-BASIC EMBODIMENT

Note that part names as used herein are descriptive only, and should not be taken as limiting their function or purpose.

It is also important to note that functional blocks in the figures are shown for purposes of discussion only, and nothing therein should be construed to imply their necessary configuration or even presence for my invention to work.

In addition, similar embodiments based on using light-emitting diodes, electro-luminescent lamps, luminescent phosphors, florescent lamps, incandescent lamps, organic light-emitting diode films or devices, gas discharge, gas-filled lamps and other light sources are anticipated as usable in or with my invention—the specific source of the emitted light is not central to the invention.

Additionally, the use or application of invisible light sources such as sources in the ultraviolet and infrared light spectra, or a combination of visible and invisible light spectra thereof, or a mix of light spectra for illumination and another for transmission of data (for example the use of a glass-mounted infrared transmitter with or without a general lighting function,) for possible use in furtive communications, marking, or targeting, are also anticipated for use by or in this invention.

While this embodiment of the invention is addresses lighting applications, providing a source of power through glass or other non-conductive materials is in fact the basis of the invention and part of the core of the invention, and the final application of that power should not be construed by any reviewer of the material herein as limiting the application of the invention to visual illumination or decoration only.

As will be noted herein, the invention supplies power to a receiving inductor or tank circuit on the opposing side of a pane of glass or other non-ferrous material, and the recovered power may in part or in full be used to power an audible speaker or other audible device, or for powering other electric devices such as a motor or other mechanical device.

All part values and techniques discussed and illustrated herein are for purposes of discussion only, and should not be construed to limit the scope of the invention.

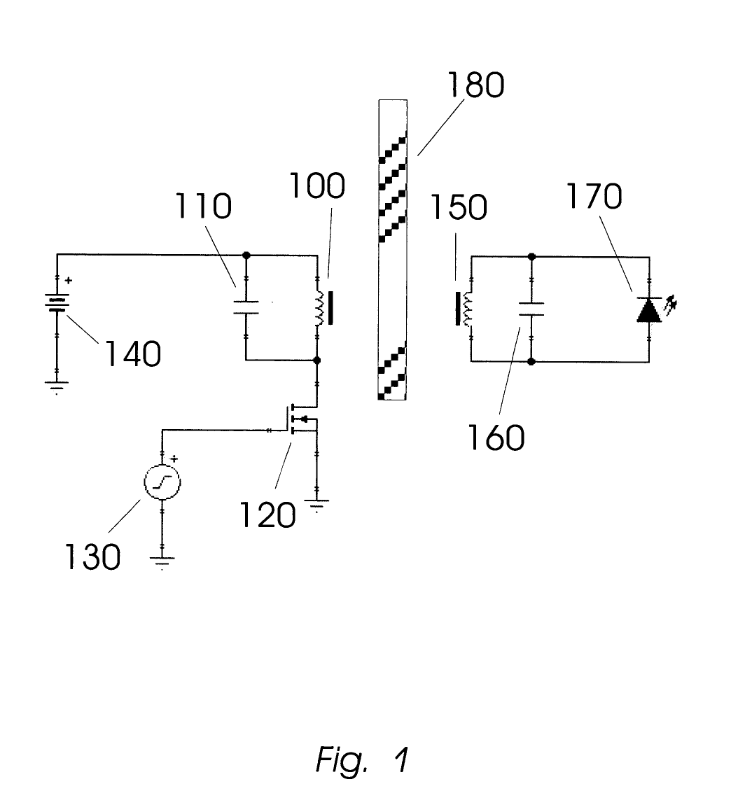

FIG. 1 is a diagram showing basic circuitry necessary to implement a basic embodiment of the invention. Inductor 100, capacitor 110, transistor 120, frequency source 130, and battery 140, taken together, represents the primary energy transmitter or exciter portion of the invention. In an automotive application, the exciter would most likely be mounted inside the automotive glass, whereas in a home or office application, the exciter would mounted behind a window pane or a non-ferrous material such as a slab of marble.

Battery 140 in this demonstrative embodiment, is a 12 Volt Direct Current Voltage source—an example might be a car battery. Inductor 100 is an inductor coil of a selected impedance, and capacitor 110 is a capacitor of a selected value, wherein inductor 100 and capacitor 110 in parallel create a resonant or tank circuit centered at a determined frequency. Transistor 120 is an N-Channel metal-oxide semiconductor field-effect transistor (MOSFET), in the case of the prototype lab demonstration unit, an International Rectifier IRFZ44N HEXFET was used, transistor 120 is placed inline with the R-C parallel tank circuit created by inductor 100 and capacitor 110, with the positive pole of battery 140 applied to the top of the tank circuit, and MOSFET 120 switching the bottom of the tank circuit to ground as controlled by the oscillator source 130.

Frequency source 130 represents an simple oscillator and driver circuit that will turn the MOSFET 120 on and off, forcing the inductor 100 into and out of or near saturation, resulting in the emission of inductive energy (a varying magnetic field with lines of force). In this instance, a lab demonstration assembly had a resonance near 24 KHz that was useful for demonstration of the invention using small inductors.

Inductor 150, capacitor 160, and light emitting diode 170, taken together, represents the secondary receiver or load portion of the invention. In an automotive application, the receiver—as part of the light fixture—would most likely be mounted to the outside of the automotive glass 180.

Inductor 150 is an inductor of a value chosen to match the requirements of the lamp load. The number of turns on the inductor is selected based in part on the targeted load. If the load is more current-demanding as light-emitting diode 170 would be, then the receiver inductor 150 is selected to have about the same number of turns as the exciter inductor 120. If the load is more voltage-based as an electroluminescent lamp would be, then the receiver inductor 150 is selected to a multiple of the number of turns as the exciter inductor 120 as one way to generate the voltage required for the lamp. Note that in this case of use with and electroluminescent lamp, the invention acts as a voltage inverter of the 12 Volt battery voltage—that is, the 12 volt input voltage is boosted using the transmitting inductor 100 and the receiver inductor 150 set apart by the thickness of the glass 180, as forming a pseudo transformer, with the secondary output having a multiple of the primary windings (a high turns ratio) in order to boost the input voltage of 12 Volts to a voltage usable by the electroluminescent lamp of 100 volts or more.

In the basic embodiment here shown with a light-emitting diode 170 as the light emission source, the turns ratio of the two coils would be more evenly matched (1:1 for example).

Capacitor 160 was, in the prototyped unit, a 0.01 uF capacitor. Inductor 150 and capacitor 160 together make up the receiving resonant tank circuit similar to one in the exciter circuit, and with a similar resonant frequency. Diode 170 is a light-emitting diode, and is powered by the output of the inductor 150 and capacitor 160 resonant circuit. Note that in using a light-emitting diode 170, which in itself is already a diode, no rectification or filtering of the AC output of the resonant tank circuit is needed in the design.

Note that no rectification or filtering circuitry is needed in the design if the light source (emitter) is a electroluminescent lamp, as such a device operates best using high-frequency AC. That is, an electroluminescent lamp is brighter at a frequency of 1 KHz and above compared to its brightness at DC or lower frequencies. In the case of a electroluminescent lamp, the tank circuits would be adjusted for a frequency and voltage that is usable for lighting the lamp, but not too high of a voltage for the life expectancy of the lamp.

The oscillator and driver circuit 130 can be a digital or analogue based circuit, but I envision a simple microprocessor with self-contained clock circuit would be cost effective and small enough to fit within a small exciter housing. Also note that the metal-oxide semi-conducting field-effect transistor (MOSFET) 120 is heavier in duty in this example then it actually needs to be. Additionally, for more practical uses, circuitry and precautions must be used to limit the generation of electro-magnetic or radio frequency noise or interference to outside electronics.

It is important that inductor 100 and inductor 150 be axially aligned-up with each other on both sides of the glass, as if the core was one continuous core passing through a hole in the glass (as if a transformer with two windings). The better the alignment and the thinner the glass, the better the coupling; and thereby the better the efficiency of the circuitry in the transfer of current and voltage (power). In applications using iron core inductors, the inductors are best if they have an exposed iron core, the cores acting as directors of the magnetic lines and inductance, and are aligned properly. However, in the demonstration circuit, surface mounted power inductors with small mushroomed caps also worked acceptably.

Additional circuitry may be desirable for increased reliability and stability of the design, but my intent here is to illustrate the minimal circuitry needed to demonstrate the invention. Note that neither capacitor 110 nor capacitor 160 are in fact necessary for the invention to work if resonant circuits are deemed unnecessary to the application.

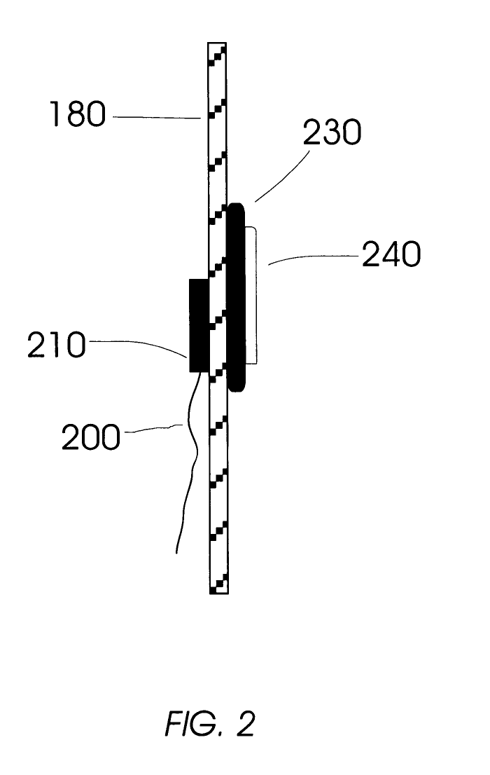

FIG. 2 is a diagram showing the basic mounting details for the invention. In the application, a limousine coach light is illustrated.

Item 200 is the power lead coming from the car battery circuitry, and is supplying power to the exciter circuitry 210. The exciter circuitry 210 is inside a plastic housing that has been glued to the inside of a glass pane 180.

On the outside of glass pane 180 is glued the base of the coach light 230 that houses the receiver circuitry and the light source that supplies the light to the lamp assembly lens 240. Together the coach light base 230 and lens 240 make the outside lighting fixture, which is fully sealed as there is no requirement for wires to enter the housing.

Note that there is no need to drill holes through the glass or use additional mounting hardware, and therefore should the coach lamps need to be moved or replaced, only glue needs to be used to install the new lamps. This also allows for adding coach lights to a limousine without requiring much labor, or potentially damaging the exterior paint or roof treatment.

### DESCRIPTION OF INVENTION-PREFERRED EMBODIMENT

The preferred embodiment of the invention describes an outdoors lighting fixture for use on automobiles (trains or boats), that can be mounted to the outside of a glass surface without requiring the routing of conductors (wires) to the outside fixture. This embodiment, while perhaps not the most basic embodiment of my invention, is never-the-less one of the more useful embodiments.

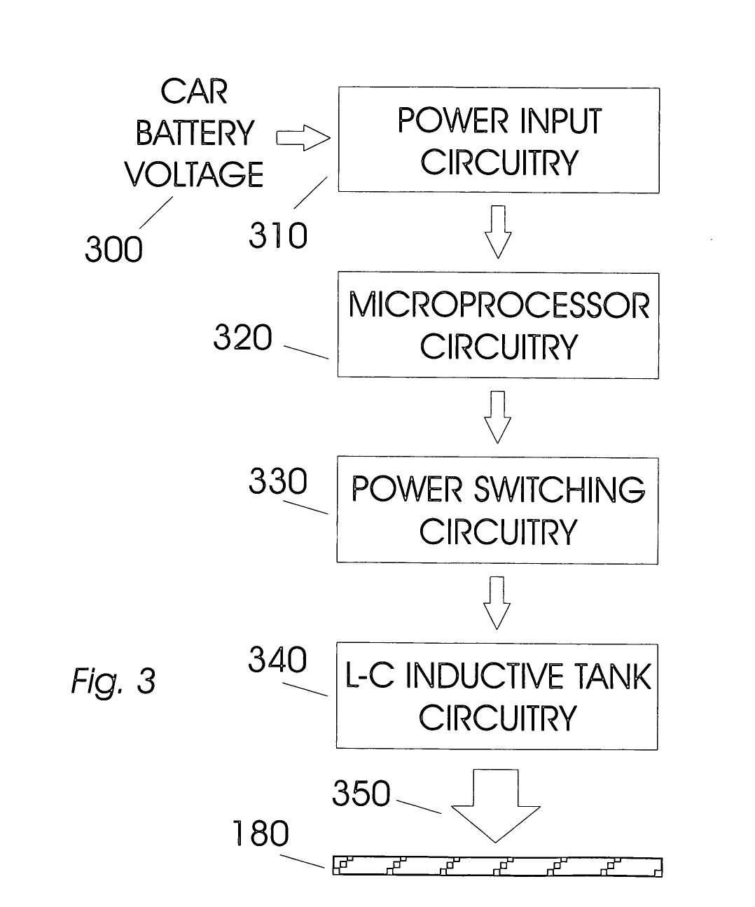

The preferred embodiment utilizes a modified exciter fixture with circuitry as described herein and shown in function block form in FIG. 3. Battery voltage from the vehicle 300 is brought into the exciter fixture and coupled to the Power Input Circuitry 310 which includes a fuse and a filter capacitor to help filter the incoming voltage and help to block conducted emissions from the exciter back into the car's electrical system. The Power Input Circuitry 310 may also include a rectifier to prevent damages in case of polarity reversal of the input voltage, and additional filtering to block emissions into or out of the exciter fixture. The Power Input Circuitry 310 also contains a low voltage regulator that supplies filtered low voltage power to the Microprocessor Circuitry 320 and Power Switching Circuitry 330 as needed for these circuits to operate.

The Microprocessor Circuitry 320 contains a microprocessor, such as a Freescale MC9S08QG4 or other similar microprocessor, a crystal or resonator or other frequency device and circuit so the microprocessor will clock at a predetermined clock rate, and inputs to the ports so that the microprocessor will operate; such inputs includes a voltage reset circuit and programming port if so desired. The output of the microprocessor consists of an output clocking line that is used to clock the output of Power Switching Circuitry 330 and an additional signal that is used for on-off control of the Power Switching Circuitry 330. One or more signals from the Power Switching Circuitry 330 going to the Microprocessor Circuitry 320 may be used to monitor the operating condition of the Power Switching Circuitry 330, wherein the conditions being monitored are one or more of temperature, current, and sample voltages.

The Power Switching Circuitry 330 has direct power input from the Power Input Circuitry 310 and inputs from the Microprocessor Circuitry 320. The Power Switching Circuitry 330 has an internal high-current MOSFET driver circuit that delivers switched current and voltage to the L-C Inductive Tank Circuitry 340, the frequency of which is under control of the Microprocessor Circuitry 320. The Power Switching Circuitry 330 may also make the use of voltage inverting or “boost” circuitry to help deliver to the L-C Inductive Tank Circuitry 340 a higher voltage for increased electromagnetic output. A sample of the voltage from the MOSFET driver circuit may be sent back to the Microprocessor Circuitry 320 for measurement or adjustment. It is also possible to send to the Microprocessor Circuitry 320 a voltage as a result of a voltage drop from across an inline resistor to the Inductive Tank Circuitry 340 for inductor tank current and saturation measurements and adjustments.

The Inductive Tank Circuitry 340 includes the inductor which is oriented to the exciter fixture's housing to maximize conducted Electromagnetic Energy 350 in the direction of and through the glass, and likely includes a capacitor useful for setting the operating frequency of the Inductive Tank Circuitry 340.

It is important to know that the clocked output from the Microprocessor Circuitry 320 and used to control the switching rate or frequency output of the Power Switching Circuitry 330 which in turn is coupled to the Inductive Tank Circuitry 340 and hence generates the Electromagnetic Energy 350, therefore the clock source from the Microprocessor Circuitry 320 may be modulated to control lamp brightness or transmit data signaling along with the energy used to power a lighting device. Several data transmission techniques exist and can be used with the invention, such as AM, FM, PM, PWM, M-ary, or FSK, modulation both of the magnetic/inductive output, and hence of the LED or lamp optical output, but such use of modulation of the output of the Microprocessor Circuitry 320 to encode data or analog information is not used in this embodiment of the invention.

As before, all part values and techniques discussed and illustrated herein are for purposes of discussion only, and should not be construed to limit the scope of the invention.

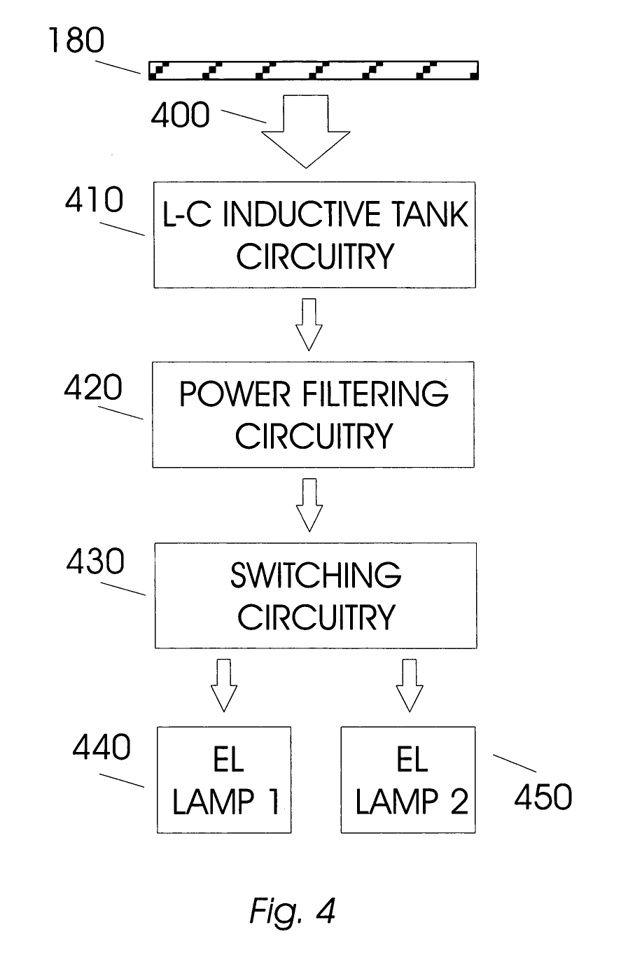

The preferred embodiment utilizes a receiver fixture modified from the basic embodiment described above. The preferred embodiment utilizes a modified receiver and light fixture with circuitry as described herein and shown in function block form in FIG. 4.

The received Electromagnetic Energy 400 enters the Inductive Tank Circuitry 410 of the receiver and is extracted as an output voltage that has the same frequency of the exciter that emitted the received Electromagnetic Energy 400.

The Inductive Tank Circuitry 410 includes an inductor for receiving the induced magnetic lines of force of the exciter fixture (FIG. 3), and a capacitor used to set or tune the resonance of the Inductive Tank Circuitry 410 of the receiver.

The extracted voltage and current is coupled to the Power Filtering Circuitry 420 so the received power can be used to power Switching Circuitry 430 that includes a simple switching, such as a Philips Semiconductor 555 timer, that in-turn is used to control active power switching circuitry that is also in the Switching Circuitry 430 block, that in turn controls the illumination of EL Lamp Element #1 440 and EL Lamp Element #2 450 which together make-up a decorative or advertising display. In this way EL Lamp Element #1 440 and EL Lamp Element #2 450 can be made to alternate or flash in a timed sequence or a pseudo-random sequence, or a sequence of patterns that change in time.

Noting herein should be construed to limit the actual number of lamps or lamp elements that can be sequenced in this way, or that EL Lamp Element #1 440 and EL Lamp Element #2 450 are two or more separate lamps or two or more elements of one lamp. For example, in one application of this preferred embodiment, an EL Lamp may be manufactured in the shape of a glass and one element of the entire lamp may be in the for of that glass, while a second element may represent the contents in that glass, and additional element might represent bubbles of gas within the content, and so forth. In another application of the preferred embodiment, multiple lamps may be in the form of a moon, and the preferred embodiment is used to create the illusion of a moon moving across the sky in an advertisement.

### DESCRIPTION OF INVENTION-ALTERNATIVE EMBODIMENTS

In an alternative embodiment of the invention, a modified exciter is used to transmit both power and to transmit audio signaling through the glass so the light fixture on the outside of the glass may also emit sound.

The exciter is similar to that of FIG. 3, except that the Microprocessor Circuitry 320, using amplitude modulation self modulates the clock output with tone or audio information pre-stored in memory. Nothing herein should be used to limit the audio source to being one of an internal audio source. Indeed, external audio or data sources are anticipated for use in the invention.

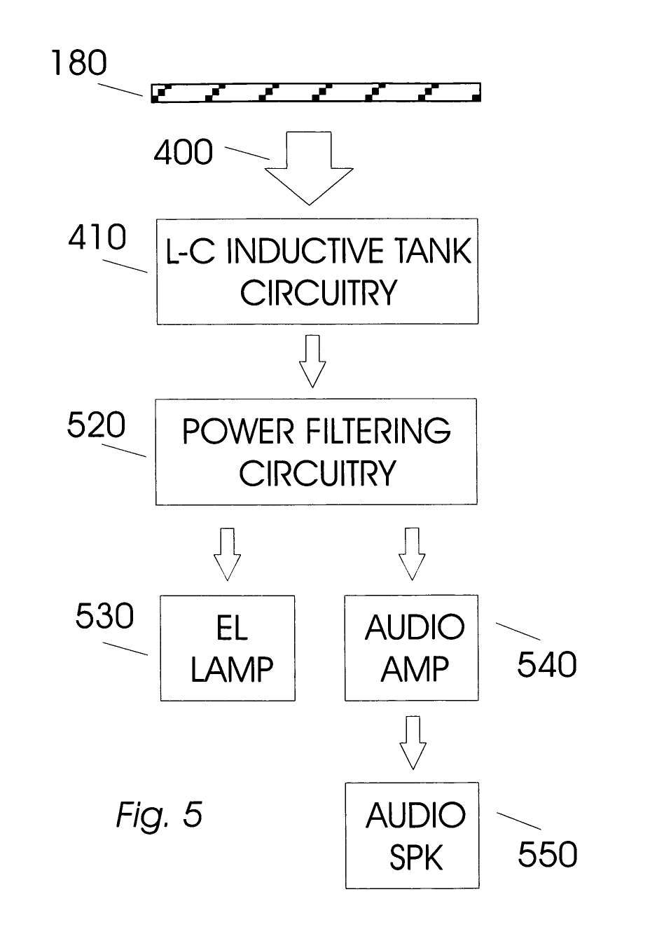

The receiver fixture however is modified to reproduce sound. In FIG. 5. The received modulated Electromagnetic Energy 400 enters the Inductive Tank Circuitry 410 of the receiver and is extracted as an output voltage that has the same frequency of the exciter that emitted the received Electromagnetic Energy 400.

The Inductive Tank Circuitry 410 includes an inductor for receiving the induced magnetic lines of force of the exciter fixture, and a capacitor used to set or tune the resonance of the Inductive Tank Circuitry 410 of the receiver.

The extracted voltage and current is coupled to the Power Filtering Circuitry 520 so the received power can be used to power the EL Lamp 530 while some filtered power is coupled to an Audio Amplifier circuit 540 to power the amplifier circuitry. The Power Filtering Circuitry 520 also extracts and recovers the audio signal that was used to amplitude modulate the Electromagnetic Energy 400 that was coupled through the glass to the Inductive Tank Circuitry 410. The recovered signal is coupled to the Audio Amplifier 540 which in turn amplifies the signal wherein it is coupled to the Audio Speaker 550.

As before, nothing herein should be construed to limit the actual number of lamps that can be illuminated or that audio signaling prohibits the use or implementation of sequenced lighting or lamps; and nothing herein should be construed to limit the type of modulation used, or the number of exciters and receivers used in one lighting fixture or display. As an example, three exciters-receiver pair combinations could be used to supply power to a large display unit that encompasses one or a multiplicity of lamps or lamp elements, and one additional exciter-receiver pair combination used to solely couple and power audio circuits in the same display.

In an alternative embodiment of the invention, the power input circuitry is modified to accept alternating current as the primary source of operating power.

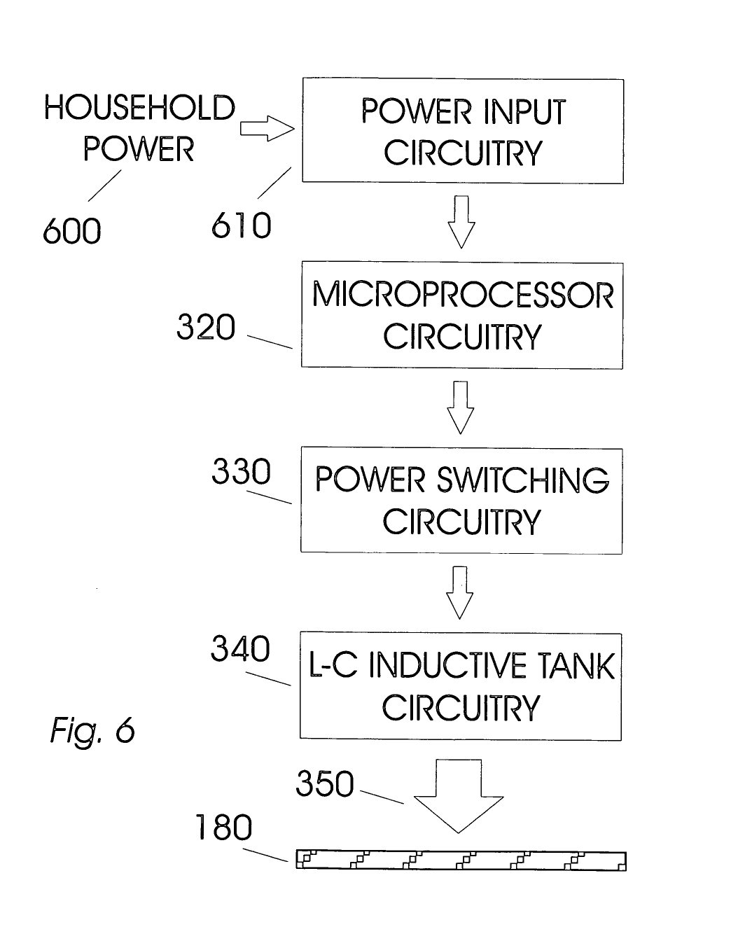

In FIG. 6, the exciter is similar to that of FIG. 3, except that the Power Input Circuitry block 610 now includes circuitry to accept Alternating Current 600 input which is rectified and filtered to become direct current suitable for use with the internal high-current MOSFET driver circuit that delivers switched current and voltage to the L-C Inductive Tank Circuitry 340, the frequency of which is under control of the Microprocessor Circuitry 320. In this fashion the power exciter and lamp assemblies can be operated from household current.

### CONCLUSION, RAMIFICATIONS, AND SCOPE OF INVENTION

Thus the reader will see that this invention conducts power through glass and other non-ferrous materials for use for the emission of light from a lighting fixture or lamp by using inductive coupling and not wiring, thereby removing the need for the supply of power to an outside lamp or light fixture using wire or other intrusive or more complicated conductive pathway.

Accordingly, the reader shall see that by placing two coils (inductors) on opposite side of a piece of glass or other non-magnet blocking material, the invention utilizes the transfer of energy by utilizing magnetic coupling between two or more inductors to supply energy to a light emitting device. That is, the two coils in effect create a transformer, so that power in the form of alternating current applied to the coil mounted inside glass is coupled to the coil mounted to the outside of the glass, with the circuitry for the conducted power to be used to energize a lamp or other light emitter, or a sound emitting device, or other electrical device or combination thereof.

The invention permits the easy attachment of lights, lighted signs and forms, and other electrically-powered products to be attached to glass without the use of costly drilled holes or messy cements and wires. Indeed the reader will see that the invention encourages the user to change or update lighted signs and forms, (for example,) as often as the person owning the display wants to, for the method for fixing the light emitter can be as simple as a film of water, the use of hook-and-loop fastener tapes, or other removable and reusable media.

While the descriptions herein contain many specificities, nothing herein should be construed to create a limitation of the scope of my invention, but rather be used as exemplifications of embodiments of my invention. Many other variations are possible such as powering a multiplicity of lights or a multiplicity of lighting elements. The inductively conducted power may be transmitted using a multiplicity of frequencies, allowing for each to be segregated to be used a separate power source or a data or signaling for separate use or control. The frequencies used can be modulated using all existing frequency, phase, or amplitude modulations, including without limitation, the modulation methods used in radio communications; and these modulations can be used to transmit data or signaling for use by the receiver.

Furthermore, even though the title of the invention refers to light fixtures, nothing herein should be construed as to prevent the invention being used to operate motors, solenoids, or other mechanical or electronic devices.

In addition, the type or kind of light generator or emitter used in the invention is not limited to any category or scope of device, and indeed all forms of light emitting devices, lamps, and luminaires, have been anticipated by the invention, including the use of organic light emitting diodes and films, as well as fluorescent light sources, and noble and rare gas-filled light sources, as well as lights of varying colors and lamps that emit changing colors such as color changing or mixing light-emitting diodes. Additionally, nothing herein should be used to limit the scope of the size or shape of the light emitter used, or to prevent the use of mixed forms of lighting with the invention, or limit the number or kind of matched power transmitter-receiver pairs used to power the lights or display, or as to limit the frequencies used by the invention.

Moreover, nothing herein should be construed to limit the scope as to what type or kind or application of glass the invention is limit to, or that glass alone is a limitation of scope. Indeed the invention is anticipated by the inventor to be used on marble and plastic surfaces, and other non-ferrous materials.

Thus the scope of the invention should be determined by the appended claims and their legal equivalents, rather than by the examples given.

I claim:

1. A method for supplying power to a light emitter affixed to non-ferrous material, comprising:
non-ferrous material;
a primary assembly affixed to one side of non-ferrous material, comprising:
a power supply with means to convert direct current to alternating current, and
coupling means to convert said alternating current into a varying magnetic field; and
a secondary assembly affixed to the opposing side of said non-ferrous material, comprising:
means to convert a varying magnetic field into electric current,
coupling means to apply said current to an optical emitter, and
one or a plurality of optical emitters.

2. The method of claim 1 wherein said alternating current is of a fixed frequency.

3. The method of claim 1 wherein said alternating current is of a modulated frequency.

4. The method of claim 1 wherein said non-ferrous material is glass.

5. The method of claim 1 wherein the inductive means of the primary comprises a resonant circuit.

6. The method of claim 1 wherein the secondary light fixture is removable.

7. The method of claim 1 wherein the optical emitter is a light-emitting diode.

8. The method of claim 1 wherein the optical emitter is an electroluminescent lamp.

9. The method of claim 1 wherein the optical emitter is a light-emitting film.

10. The method of claim 1 wherein the secondary coupling means further comprises a means for switching a plurality of outputs.

11. A method for delivering power to an automotive light fixture affixed to non-ferrous material comprising:
non-ferrous material;
a means for generating inductive energy comprising:
a power supply with means to convert direct current to alternating current, and
an inductor means to convert said alternating current into a magnetic field; and
an inductively powered automotive light fixture comprising:
an inductive means to convert a magnetic field into electric current,
regulation means to apply said current to an optical emitter, and
one or more optical emitters.

12. The method of claim 11 wherein said non-ferrous material is glass.

13. The method of claim 11 wherein said alternating current is of a fixed frequency.

14. The method of claim 11 wherein said alternating current is of a modulated frequency.

15. The method of claim 11 wherein the inductive means of the primary comprises a resonant circuit.

16. The method of claim 11 wherein the light fixture is removable.

17. The method of claim 11 wherein the optical emitter is a light-emitting diode.

18. The method of claim 11 wherein the optical emitter is an electroluminescent lamp.

19. The method of claim 11 wherein the optical emitter is a light-emitting film.

20. The method of claim 11 wherein the secondary coupling means further comprises a means for switching a plurality of outputs.

21. A method for energizing a light fixture affixed to glass comprising:
a primary magnetic energy generating assembly comprising:
a power supply with means to convert direct current to alternating current, and
an inductor means to convert said alternating current into a magnetic field; and
a secondary light fixture comprising:
an inductor means, and
an optical emitter.

22. The method of claim 21 wherein said alternating current is of a fixed frequency.

23. The method of claim 21 wherein said alternating current is of a modulated frequency.

24. The method of claim 21 wherein the inductive means of the primary comprises a resonant circuit.

25. The method of claim 21 wherein the light fixture is removable.

26. The method of claim 21 wherein the optical emitter is comprised of a light-emitting diode.

27. The method of claim 21 wherein the optical emitter is comprised of an electroluminescent lamp.

28. The method of claim 21 wherein the optical emitter is comprised of a light-emitting film.

29. A method for supplying power to a light emitter affixed to non-ferrous material, comprising:
a primary assembly affixed to one side of non-ferrous material, comprising:
a power supply means to supply operating current;
controlling means to convert said operating current to an alternating current of desired frequency and amplitude; and
an inductive means for converting said alternating current to an emitted magnetic
field; and
a secondary assembly affixed to the opposing side of said non-ferrous material, comprising:
means to convert a varying magnetic field into electric current,
coupling means to apply said current to an optical emitter, and
one or a plurality of optical emitters.

30. The method of claim 29 wherein said alternating current is of a fixed frequency.

31. The method of claim 29 wherein said alternating current is of a modulated frequency.

32. The method of claim 29 wherein said non-ferrous material is glass.

33. The method of claim 29 wherein the inductive means of the primary comprises a resonant circuit.

34. The method of claim 29 wherein the secondary light fixture is removable.

35. The method of claim 29 wherein the optical emitter is a light-emitting diode.

36. The method of claim 29 wherein the optical emitter is an electroluminescent lamp.

37. The method of claim 29 wherein the optical emitter is a light-emitting film.

38. The method of claim 29 wherein the secondary coupling means further comprises a means for switching a plurality of outputs.

39. The method of claim 29 wherein the secondary assembly is a decorative light.

40. The method of claim 29 wherein the secondary assembly is an automotive lamp.

41. The method of claim 29 wherein the secondary assembly is a panel comprising a plurality of optical emitters.
